(19) United States
(12) Patent Application Publication
(10) Pub. No.: US 2002/0129033 A1
(43) Pub. Date: Sep. 12, 2002

(54) Browser for an accident and incident registry

(76) Inventors: Stephen W. Hoxie, Hedgesville, WV (US); Brian J. Lund, San Antonio, TX (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/082,132

(22) Filed: Feb. 26, 2002

Related U.S. Application Data
(60) Provisional application No. 60/270,880, filed on Feb. 26, 2001.

(51) Int. Cl. G06F 7/00

(52) U.S. Cl. 707/101

(57) ABSTRACT

This invention relates to a system and method for accessing information and data relating to medical information, and more particularly to a laser accident and incident registry. The system includes a data structure that allows for easy access of the information while maintaining a smaller overall sized database.

This application claims the benefit of U.S. provisional Application Serial No. 60/270,880, filed Feb. 26, 2001, which is hereby incorporated by reference.

### I. FIELD OF THE INVENTION

This invention relates to a system and method for retrieval of stored database material and more particularly the invention is a system and method for locating requested information including displaying both textual information and images on the fly. Even more particularly, the invention is a system for warehousing laser accident and incident data and information in an easily searchable database.

### II. BACKGROUND

The study of bioeffects resulting from laser eye exposure is concerned with the explanation and description of changes in visual function and morphology subsequent to laser exposure. One method toward this end is to compare the visual function and morphological outcomes of subjects randomly assigned to conditions that are systematically varied along specified parameters. For example, analogues of laser eye exposure are developed through systematically varying laser exposure conditions and comparing subsequent visual function and morphology against control conditions. In addition, aspects of visual function loss can be modeled by systematically augmenting or suppressing the visual system with various visual stimuli and comparing visual performance across treatment and control conditions. These examples represent a nomothetic approach to discerning laser bioeffects. This approach emphasizes the treatment of subjects as groups in which individual differences are relegated to the status of error variance. The strength of this approach is in directly testing an a priori principle against rival positions. The extent to which the principle withstands the rigor of this method determines the generality of the principle. The weakness of the approach is in the conception of a priori principles in which to invest and in defining the parameters of the experiment in a manner that renders internally as well as externally valid results.

In contraposition to the nomothetic method is the evaluation of laser bioeffects through a comprehensive evaluation of visual function and morphologic change within each laser eye accident case. This approach emphasizes the uniqueness of laser induced damage and repair processes within an individual. The emphasis on the contribution of individual differences to the outcome illuminates general principles through symmetries in the data across each case. The strength of this approach is in the rich description of naturally occurring laser induced damage and repair processes from which externally valid hypotheses can be derived. The weakness of this approach is in the lack of control over antecedent conditions. This lack of control over antecedent conditions diminishes the strength of relationships with consequent change in visual function and morphology. However, the richness of the idiographic approach in generating hypotheses in conjunction with the rigor of the nomothetic approach in testing hypotheses provides a formidable scientific method from which to study laser bioeffects.

The ubiquity of laser radiation in military, medical, entertainment, telecommunications and research industries and the significant risk of eye injury from this radiation are firmly established. While important advances have been made in understanding laser bioeffects using animal analogues and clinical data, the relationships among patient characteristics, exposure conditions, severity of the resulting injury, and visual function are fragmented, complex and varied. Although accident cases are minimized through laser safety regulations and control procedures, accumulated accident case information by the Laser Eye Injury Evaluation Center warranted the development of a laser accident and incident registry.

### III. SUMMARY OF THE INVENTION

The invention preferably includes clinical data for validating and refining hypotheses on injury and recovery mechanisms; a means for analyzing and refining hypotheses on injury; and a means for identifying future areas of investigation.

With a detailed accident interview, a precise description of the physics of the exposure circumstances, an ophthalmologic examination complete with fundus, scanning laser ophthalmoscope and optical coherence tomography images, a battery of specialized visual functions tests and data from follow-up evaluations, the complexity and extent of information can only be managed in a relational database format of this invention.

According to one form of the present invention, a computer-readable medium containing a data structure for storing laser accident and incident information including an incident table containing an entry for each of a plurality of incidents, each entry carrying an identification, a clinical evaluation table containing at least one entry for each entry in the incident table linked by the identification, the clinical evaluation table containing clinical evaluation information, and a laser table containing at least one entry for at least one entry in the incident table linked by the identification, the laser table containing a laser identification.

According to one form of the present invention, a system including means for storing a database of incidents, means for querying information from the storing means, and means for displaying information queried from the storing means by the query means.

According to one form of the present invention, a computer-readable medium containing a data structure for injury information including an injury table containing an entry for each of a plurality of injuries, each entry having an identification, a clinical evaluation table containing at least one entry for each entry in the injury table linked by the identification, the clinical evaluation table containing medical information, and a cause table containing a corresponding entry for each entry in the injury table linked by the identification, the cause table containing a description of how the injury occurred.

According to one form of the present invention, a method for performing a search in a database including receiving a search request, displaying a radial button interface listing categories, receiving a selection of a category listed on the radial button interface, displaying an interface having multiple fields for accepting search criteria, receiving search criteria, suggesting a query name, sending the search criteria to another component, receiving a list of matches that satisfy the search criteria from the other component, and displaying the list.

According to one form of the present invention, a method for providing information to a user based upon an input received from the user, the method including the following: a) displaying a list of incidents, b) receiving a selection of a particular incident, c) requesting data related to the selected incident, d) receiving a populated template including the data related to the selected incident, e) displaying the populated template, and f) expanding the list to include related informational categories for the selected incident.

According to one form of the present invention, a method for retrieving information from a database and a template, the method including receiving a selection, pulling data associated with the selection from a database, pulling a template associated with the selection from a template library, populating the template with the pulled data, and sending the populated template.

According to one form of the present invention, a method for assembling search results of incidents based upon a query, the method including receiving at least one search parameters from a controller, comparing the incidents in a database against the at least one search parameter, compiling a list of matching incidents from the comparing step, and sending the compiled list of incidents to the controller.

According to one form of the present invention, a laser accident and incident registry system including a controller having a browser, an interface engine connected to the controller, and a database storing the laser accident and incident registry, the database connected to the interface engine.

An objective of the invention is to provide a means for generating empirical relationships to identify symptoms for definitive diagnosis and treatment of laser induced eye injuries.

Another objective of the invention is to provide a system to facilitate and assist in the diagnosis and treatment of acute laser induced eye trauma.

Another objective of the invention is to facilitate medical triage, management and treatment of laser-induced injury and awareness of hazards from lasers, for example, on the battlefield or in the scientific laboratory.

Another objective of the invention is to provide a means for gathering and managing data relating to laser incidents and accidents in a usable format.

Yet another objective of the invention is to provide efficient and fast access to information resulting from the arrangement of the database according to this invention.

Yet another objective of the invention is to allow for scalability of fields within the database.

Another advantage of the invention is as a training-aid in diagnosing laser-eye injury far forward, where physicians/medical technicians can administrator early treatment thus increasing the likelihood of full recovery by the injured individual.

Another advantage of the invention is the compact overall size of the database resulting from linking between data tables such that information prone to being repeated is included once in the database.

Given the following enabling description of the drawings, the apparatus should become evident to a person of ordinary skill in the art.

### IV. BRIEF DESCRIPTION OF THE DRAWINGS

The present invention is described with reference to the accompanying drawings. In the drawings, like reference numbers indicate identical or functionally similar elements.

FIGS. 1(a)-(c) illustrate block diagrams according to the preferred embodiment of the invention.

FIGS. 2(a) and (b) depict block diagrams of the database structure according to the preferred embodiment of the invention.

FIG. 3 illustrates a relational database according to the invention.

FIG. 4 depicts a screen shot of an interface useable as part of the invention.

FIG. 5 illustrates a screen shot of an interface after a query for all of the incidents in a database.

FIG. 6(a) depicts the interface after one incident is selected. FIGS. 6(b)-(h) illustrate populated templates according to the invention.

FIG. 7 illustrates the interface with a feature according to the invention in use.

FIGS. 8(a)-(e) depict different exemplary menus for use in the invention.

FIG. 9 illustrates a block diagram of a network.

FIGS. 10(a)-(c) depict flowcharts according to the preferred embodiment of the invention.

FIGS. 11(a)-(j) illustrate query interfaces for use in the invention.

FIG. 12 depicts a flowchart illustration according to one aspect of the invention.

FIG. 13 illustrates an alternative embodiment of the database structure according to the invention.

### V. DETAILED DESCRIPTION OF THE DRAWINGS

The present invention is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The accompanying drawings show preferred embodiments of the invention.

As will be appreciated by one of skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, or other storage devices.

Computer program code for carrying out operations of the present invention is preferably written in a plurality of languages including ASP (Active Server Pages), HTML (Hypertext Markup Language), SQL (Structured Query Language), and C++. However, consistent with the invention, the computer program code for carrying out operations of the present invention may also be written in other conventional procedural programming languages. The database as described below in an exemplary embodiment is a Microsoft Access database and the display engine is a browser like interface that includes COM (Component Object Model) components, such as ActiveX controllers, to assist in displaying the data and images on the fly, i.e., as the user selects the data and/or information to view on a screen or other display.

The program code may execute entirely on the user's computer, as a stand-alone software package, or it may execute partly on the user's computer and partly on a remote computer. In the latter scenario, the remote computer may be connected directly to the user's computer via a LAN or a WAN (Intranet), or the connection may be made indirectly through an external computer (for example, through the Internet).

The present invention is described below with reference to flowchart illustrations of methods, apparatus (systems) and computer programs in accordance with the several embodiments of the invention. It will be understood that each block of the flowchart illustrations and block diagrams, and combinations of blocks in the flowchart illustrations and block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means or program code that implements the function specified in the flowchart block or blocks.

The computer program instructions may also be loaded, e.g., transmitted via a carrier wave, to a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Various templates and the database(s) according to the present invention may be stored locally on a provider's stand-alone computer terminal, such as a desktop computer, laptop computer, palmtop computer, or personal digital assistant (PDA) or the like. Exemplary stand-alone computers may include, but are not limited to, Apple®, Sun Microsystems®, IBM®, or IBM®-compatible personal computers. Accordingly, the present invention may be carried out via a single computer system, such as a desktop computer or laptop computer.

According to a preferred embodiment, the database may be centrally stored within one or more computers accessible to multiple users. Accordingly, users may access the database through a private or public computer network in a conventional manner via wired or wireless communications. By maintaining the database in a central location, updates can be easily made to the database by a system administrator without having to access all of the machines in the network.

The present invention is preferably practiced within a “client/server” programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

Many medical software applications use the client/server model. Typically, multiple client programs share the services of a common server program. Both client programs and server programs are often part of a larger program or application. Relative to the Internet, a Web browser is a client program that requests services (the sending of Web pages or files) from a Web server (which may be referred to as a Hypertext Transport Protocol or HTTP server) typically resident on another computer connected to Internet. Similarly, a computer with TCP/IP protocol installed allows client requests for files from File Transfer Protocol (FTP) servers in other computers on the Internet.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or an Extranet, as well unless otherwise noted. The term “computer network” shall incorporate publicly accessible computer networks and private computer networks.

Preferably, the system is resident on individual workstation(s) or a server (or other central storage medium/device) accessible from multiple clients over a network such as the Internet, an intranet, or other type of networks supporting file sharing and access. Preferably, when the system is resident on the server, it may be either a thin or fat client arrangement with its respective clients.

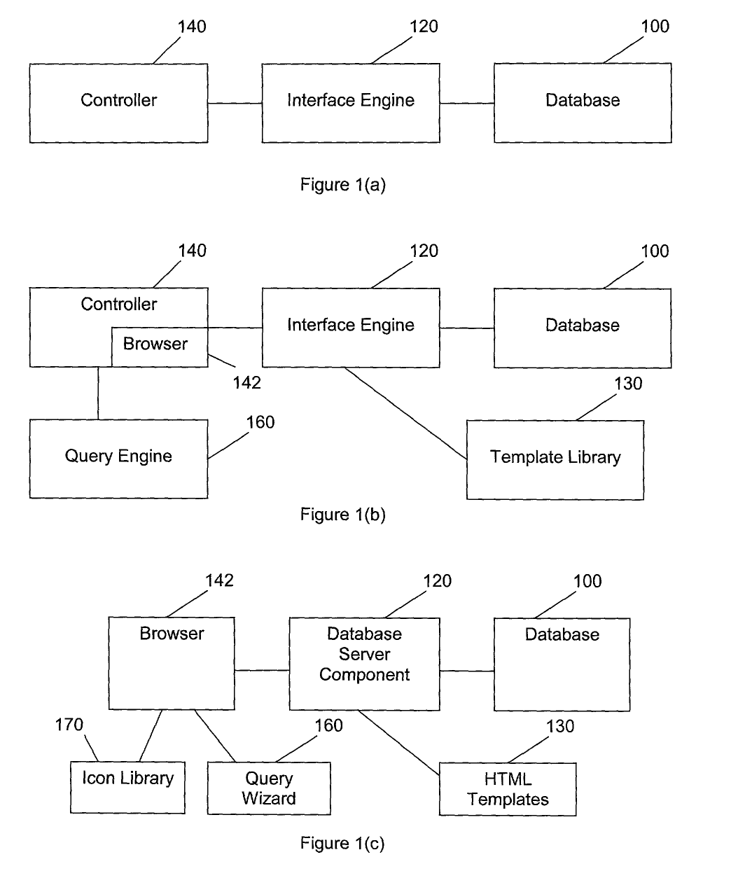

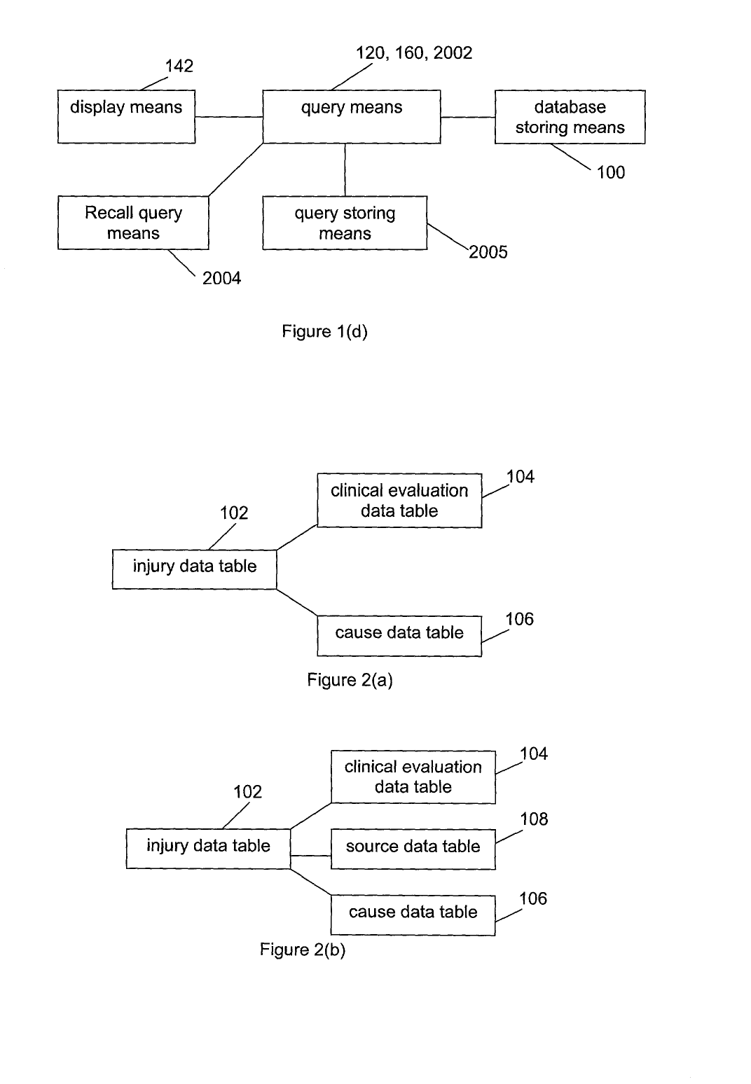

The invention preferably as illustrated, for example, in FIGS. 1(a)-(d) is a system and method for accessing and organizing information relating to an injury, a cause of the injury, and clinical evaluation information. As illustrated in FIG. 1(a), the system preferably includes at least one database (means for storing a database of incidents) 100, an interface engine 120, and a controller 140. More preferably as illustrated in FIG. 1(b), the interface engine 120 connects to the at least one database 100 and a library of interface templates 130. More preferably, the controller 140 includes a browser (means for displaying information) 142 that communicates with the interface engine 120. The system more preferably also includes a query engine 160. FIG. 1(c) illustrates an alternative embodiment that includes an icon library 170 for providing the icons for the lists of located injuries.

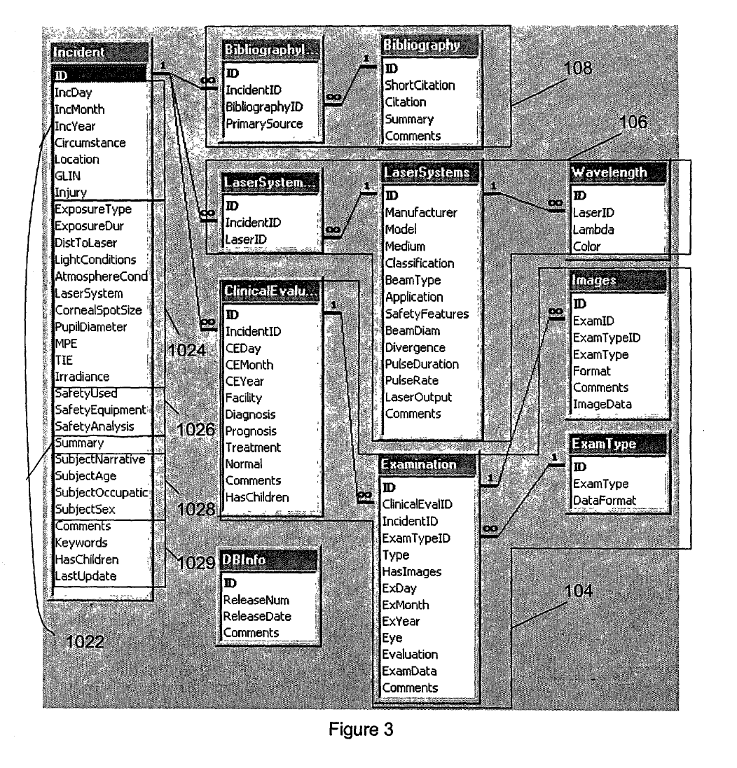

The preferred database structure of the invention is illustrated, for example, in FIG. 2(a) preferably includes an injury data table (incident data table) 102 linked to a cause index data table (laser system index data table) 104 and a clinical evaluation data table (clinical evaluation data table) 106. The linking of the data table of the laser accident and incident registry is applicable to this now described more general data structure. Alternatively, a source data table (bibliography index data table) 108 may be linked to the injury data table 102 as illustrated in FIG. 2(b). More preferably, the invention as related to a laser accident and incident registry is illustrated in, for example, FIG. 3.

The query engine 160 preferably allows for searching a collection of data and information based on user entered search requests (or queries) and displaying the located data and information to the user. The collection of data and information preferably is in the database 100. The query engine 160 preferably further includes the capability to modify a previously entered search request to allow for a search to be narrowed. Preferably, the data and information is displayed in an expandable menu formatted that the user may then select a particular piece/type of data or information to view preferably in a separate window. More preferably, the selected piece/type of data or information is displayed on the fly including the creation of specialized exam results graphically based on stored exam data/results. The query engine 160 and interface engine 120 preferably together are a means for querying information from said storing means.

### Database

FIG. 3 illustrates the preferred data relationships within an exemplary database according to the invention. There preferably are four layers of data within the database. Preferably, each layer is tied to at least one other layer through an identifier or other identification. The ID shown in each data table within FIG. 3 is not necessarily the same ID but instead is a unique identifier to a particular entry in a data table that has a specific set of data. Preferably, the identification is automatically assigned by the system and/or database software, such as Microsoft Access, used to create the database. More preferably, the incidents are consecutively numbered beginning, for example, with 1 or 101 (as illustrated in the exemplary embodiment). Alternatively, the identification data field could be omitted from some or all of the data tables particularly when the identification data field is not referenced in another data table.

The first layer is the incident layer 102, which may include zero to infinite incidents but preferably there will be no more than 10,000 incidents. Each incident preferably includes a series of data connected to the incident in addition to data related to the incident such as data in a bibliography index 108, a laser system index 106, or clinical evaluations 104. Preferably, there will be one laser system and at least one bibliography entry associated with each incident. There may be zero to multiple clinical evaluations related to one incident; preferably there is at least one clinical evaluation per incident.

The incident data table 102 preferably will provide an account of the incident events as well as an interpretive summary. The bibliography index data table 108 preferably will contain the bibliographic references of a particular incident. The clinical evaluations data table 104 will preferably provide a brief account of a clinical evaluation and the context for visual function exams. The laser system index data table 106 preferably will provide details of the laser system involved in the incident.

The bibliography index data table 108 preferably includes additional related data tables representing specific material sources. Likewise, the laser system index data table 106 preferably relates to at least one particular laser system. Each laser system then preferably will include at least one related record in a wavelength table containing wavelength data.

Alternatively, the clinical evaluations data table 104 may contain at least one examination, which preferably will detail the results of specialized visual function exams, if any. Each examination will preferably have related to it an images data table, when applicable, and an exam type data table. The exam type data table preferably will include information relating to different types of examinations that are referenced within the database. This in turn allows for easy scalability in the future when adding new examination types to the database without reorganizing the database.

The following descriptions are of select data fields within individual data tables. Most incident reports will not provide sufficient information to complete all of the data fields, and as such not all of the data fields are required to be included in the data table and/or contain information for operation of this system. The data structure discussed in the following paragraphs is for example purposes and is illustrated, for example, in FIG. 3. Preferably, any dates that are contained within the database are separated into day, month, and year, which will allow incomplete dates to be captured as data without artificially providing the missing values.

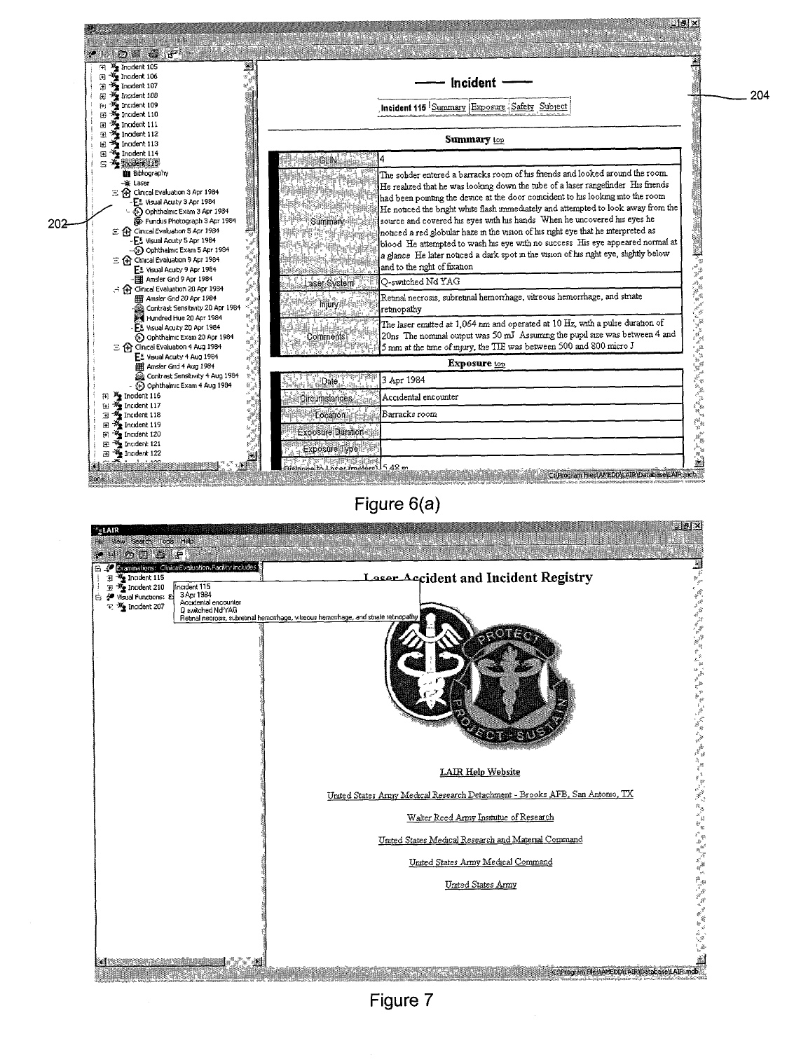

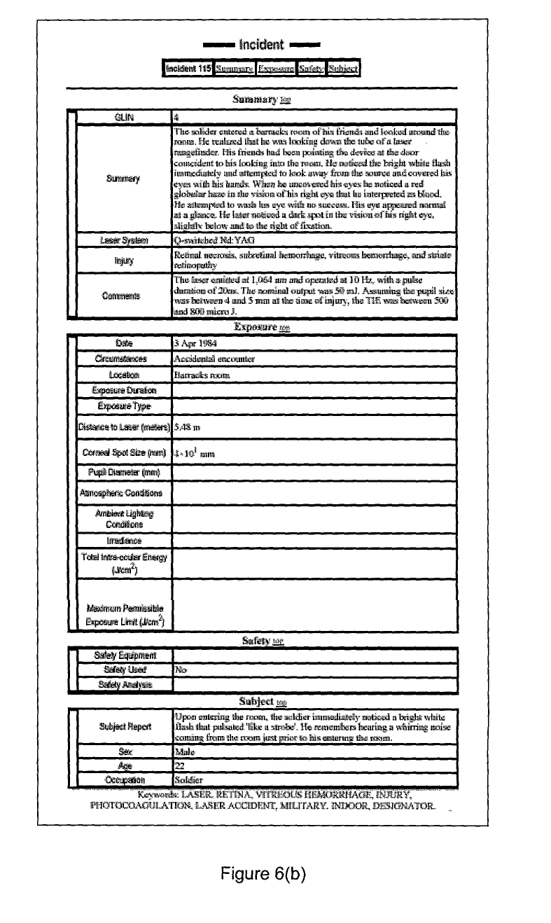

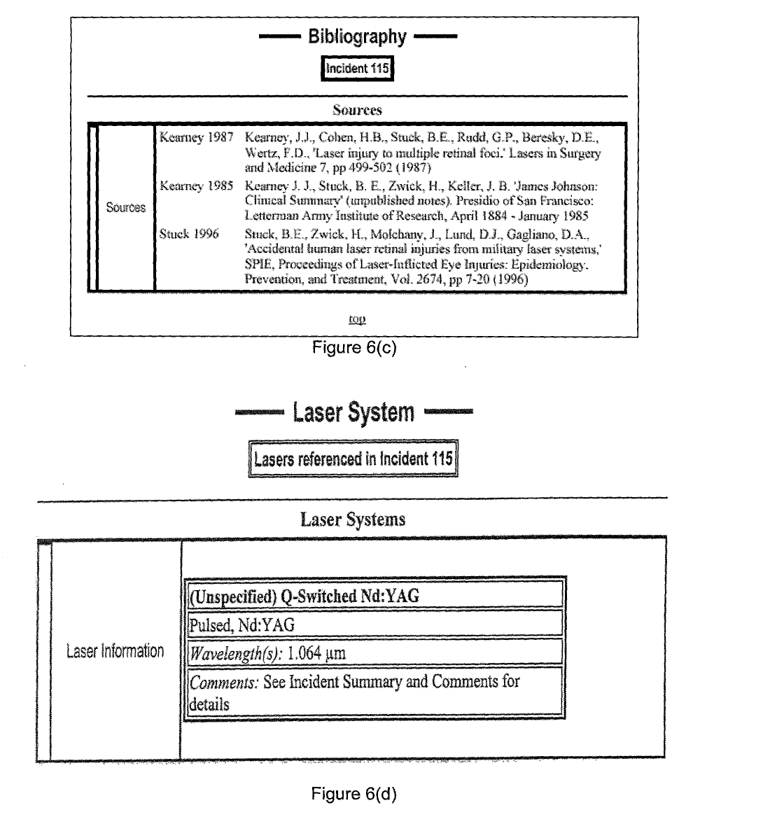

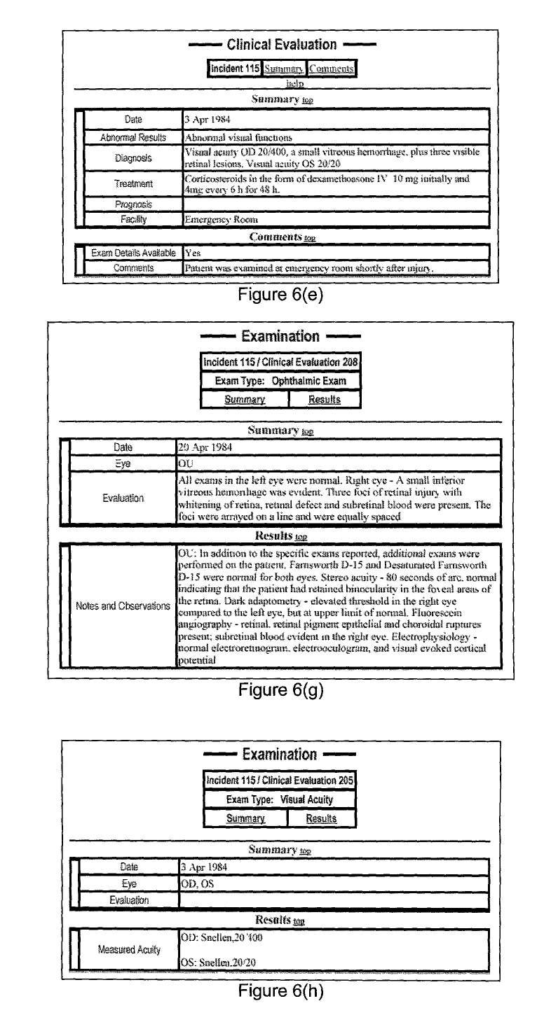

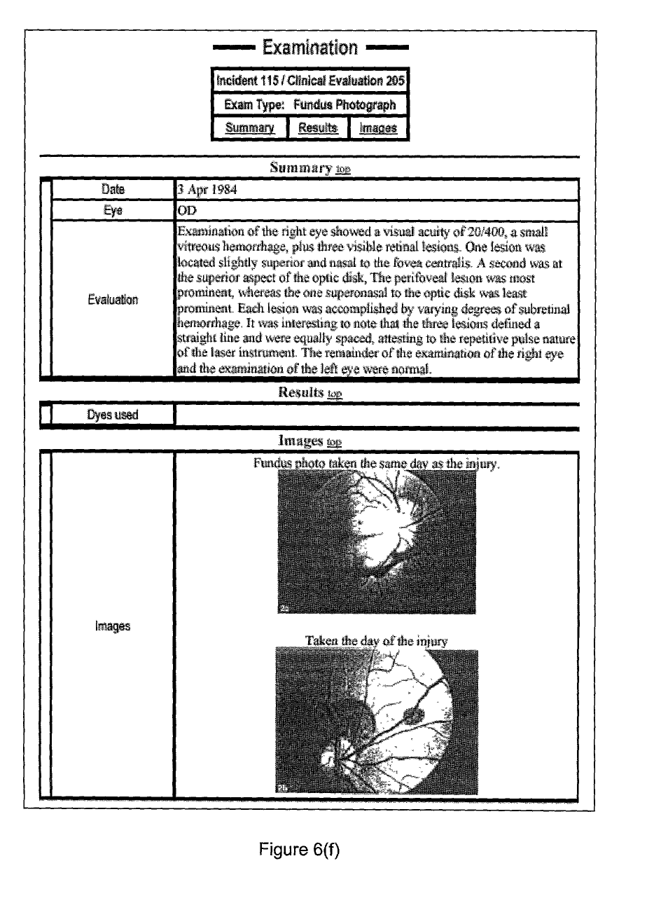

The incident data table (Incident) preferably includes data fields for an identification (ID, IncidentID in other data tables), a date (IncDay, IncMonth, Incyear), circumstances (Circumstance), a location (Location), a likelihood indicator (GLIN), a description of the injury (Injury), an exposure type (ExposureType), an exposure duration (ExposureDur), a distance to the laser (DistToLaser), ambient lighting conditions (LightConditions), atmospheric conditions (AtmosphereCond), the laser system (LaserSystem), a corneal spot size (CornealSpotSize), a pupil diameter (PupilDiameter), a total intra-ocular energy (TIE), a maximum permissible exposure (MPE) limit, an irradiance (Irradiance), a summary narrative (Summary), and comments (Comments). More preferably, the incident data table is divided into two portions, a summary section 1022 and an exposure section 1024 as illustrated, for example, in FIGS. 3 and 6(b). The summary section 1022 preferably includes the following data fields: the date, circumstances, the location, the likelihood indicator, the injury description, and the summary narrative. The exposure section 1024 preferably includes the following data fields: the exposure type, the exposure duration, the distance to the laser, the ambient lighting conditions, the atmospheric conditions, the laser system, the corneal spot size, the pupil diameter, the TIE, the MPE limit, and the irradiance. The comments data field may be present in both, only one of the two sections, or neither section.

The circumstances data field, for example, may include the name(s) of the individual(s) involved, the actions taken by the individual(s), and the general circumstances surrounding the incident. The location data field preferably is for storing the location of the subject when the incident occurred such as airspace or a battlefield. Alternatively, the location data field may be omitted and that information included within the circumstances data field. The likelihood indicator data field preferably is an index score indicating the likelihood that a laser was in fact involved in a particular incident; more preferably, this index will be assigned after reviewing all of the information associated with a particular incident such as on a scale of 0 to 4 where the higher the number the greater the likelihood the injury is laser induced. The injury data field preferably is a textual description of the injury that briefly categorizes the injury, for example, retinal hole or bilateral burn.

Preferably, the exposure type is a numerical representation of the type of exposure; and more preferably, the exposure type indicates the attributes of the exposure and can be any or all of the following, for example: intra-beam, reflected, and/or diffuse. The exposure duration preferably is a length of exposure to the laser source of the subject measured in seconds. The distance to laser data field preferably is a number representing the distance between the subject and the source of the laser light in meters. The ambient light conditions data field preferably is a description of the lighting conditions that were in the immediate area surrounding the subject; more preferably, this data field will be a word indicating the level of light between, for example, “bright” and “dark.” The atmospheric conditions data field preferably is a description of the atmospheric conditions through which the laser was propagating such as foggy, clear, and hazy.

The corneal spot size preferably represents a numerical representation of the diameter in millimeters of the spot of laser radiation incident upon the cornea during the incident assuming a circular beam profile for the laser. The pupil diameter data field preferably provides the size of the pupil at the time of the incident in millimeters. The last three data fields are self-explanatory.

The summary narrative data field preferably is for entry of an overall summary of a particular incident from the perspective of a researcher(s) studying the incident. The summary narrative data field more preferably is an abstract for a particular incident.

An alternative embodiment for the incident data table is to include a safety section 1026 as illustrated, for example, in FIGS. 3 and 6(b). The safety section 1026 preferably includes data fields for use of safety (SafetyUsed), safety equipment (SafetyEquipment), and safety analysis (SafetyAnalysis). The use of safety data field preferably is a numerical field that allows entry of a numerical value indicating whether safety equipment was used; and more preferably, this data field will be an indication as to whether the report listed the use of safety equipment. The safety equipment preferably will be a list and/or description of the safety equipment in use at the time of the incident. The safety analysis data field preferably is a text analysis of the effectiveness of the safety equipment.

An alternative embodiment for the incident data table is to include a subject section 1028 as illustrated, for example, in FIGS. 3 and 6(b). The subject section 1028 preferably will include data fields for a subject report (SubjetNarrative), an age (SubjectAge), an occupation (SubjectOccupation), and a sex (SubjectSex). The subject report data field preferably will be a narrative by the subject describing the incident, although the subject narrative could be included in the summary section 1022. The age data field preferably is the subject's age in years. The occupation data field preferably is a textual description of the subject's occupation, but may be a numerical representation taken from an index and/or provide an indication as to a relation of the subject to the laser system's owner. The sex data field preferably is a numerical representation such as 1 for male, 2 for female, and 4 for unspecified. The system preferably upon pulling the data from the sex data field would then replace the numerical representation with the appropriate textual word.

Another alternative embodiment for the incident data table is to include an administrative section 1029. The administrative section 1029 preferably includes data fields for comments (Comments), keywords (Keywords), a data flag (HasChildren), and a last edit indicator (LastUpdate). The comments data field preferably includes administrative comments about a particular incident record. The keywords data field preferably is a list or other grouping of keywords that have been assigned to a particular incident record. The data flag data field preferably is an administrative field indicating if there are records in other tables associated with a particular incident record. The last edit indicator data field preferably is a date for the last time a particular incident data record was changed and/or modified, and alternatively, the last edit indicator data field may instead or in addition include an identifier as to the person who made the update to the particular incident data record.

The bibliography index data table (Bibliographyl . . . ) preferably includes a unique identifier (ID), the incident identification (IncidentID), the bibliography identification (BibliographyID), and a primary source indicator (or flag) (PrimarySource). The incident identification preferably relates to the identification (ID) for a particular entry in the incident data table (Incident). The bibliography identification preferably relates to at least one bibliography (ID in the bibliography data table). The primary source indicator preferably indicates whether a corresponding bibliography identification is the primary source for a particular incident. Preferably, if multiple sources exist for a particular incident, then there will be multiple entries in the bibliography index data table for that particular incident. Likewise, if one source provides information about multiple incidents, then that source will be present multiple times within the bibliography index data table. An alternative embodiment is the omission of this data table through incorporation of the bibliography data table or the incorporation of the bibliography identification into the incident data table.

The bibliography data table (Bibliography) preferably includes data fields for a unique identification (ID, which is the BibliographyID in the bibliography index data table), a citation (ShortCitation/Citation), a summary (Summary), and comments (Comments) as illustrated, for example, in FIGS. 3 and 6(c). The citation data field may be further divided into a short citation data field (ShortCitation) and a long citation data field (Citation). One reason for having two levels of bibliography data tables is because some references will provide information and data regarding multiple incidents. Each of the multiple incidents can point to the same originating bibliographic source resulting in a savings in terms of overall size of the database. The bibliography index data table preferably allows for multiple bibliographic sources to be associated with one incident, and alternatively this data table may include a flag to indicate which of multiple bibliographic sources is the primary source.

The laser system index data table (LaserSystem . . . ) preferably will include a unique identifier (ID), an incident identification (IncidentID) and a laser identification (LaserID). The incident identification preferably correlates to the incident ID in the incident data table, while the laser identification preferably relates to the identification of a particular laser systems data table (ID for one laser system). The laser system index data table preferably increases efficiencies in the amount of data stored within the database, because it reduces the duplication of laser systems for multiple incidents. As such, an alternative embodiment is the omission of this data table through incorporation of the laser systems data table or the incorporation of the laser identification into the incident data table.

The laser systems data table (LaserSystems) preferably includes data fields for a unique identification for each laser (ID, which is the LaserID in the laser system index data table), a manufacturer (Manufacturer), a model (Model), a medium (Medium), a classification (Classification), a beam type (BeamType), an application (Application), safety features (SafetyFeatures), a beam diameter (BeamDiam), a divergence (Divergence), a pulse duration (PulseDuration), a pulse rate (PulseRate), a laser output (LaserOutput), and comments (Comments) as illustrated, for example, in FIGS. 3 and 6(d). Preferably, the uniquely assigned identification (ID) to each laser relates to at least one laser identification in the laser system index data table. The uniquely assigned identification (ID) also preferably relates to the laser identification in the wavelength data table.

The manufacturer data field preferably is for the name of the company or entity that manufactured and/or designed a laser system. The model data field preferably is the manufacturer's designation and/or description for a particular laser system. The medium data field preferably is a numerical indication and/or a textual description of the medium through which the light photons are stimulated and radiation is amplified and emitted, such as “Ruby,” “ND:YAG,” or “He:Ne.” The classification data field preferably is an entry to a classification enumeration within a particular database, for example, class 1 through class 4 where 3 would represent “3a;” more preferably, the classification is the ANSI classification of the laser system. Alternatively, the classification data field may be omitted.

The beam type data field preferably is a beam type enumeration. The application data field preferably is a description of typical application for using a laser system. The safety features data field preferably is a detailed description of the safety features of the laser system; more preferably, this will include a list of safety features in addition to those prescribed by ANSI 136.6. The beam diameter data field preferably is a distance in millimeters for the beam diameter at the exit aperture of the laser system; alternatively, the numerical representation may be a range of possible beam diameters. The divergence data field preferably is a numerical representation for the divergence of the beam in radians. The pulse duration data field is a numerical representation of the duration of a pulse in seconds, alternatively the numerical representation may be expressed as a numerical range. More preferably, the pulse duration data field is numerical with the number in scientific notation. The pulse rate data field is a numerical representation of the repetition rate of the pulses in Hertz, alternatively the numerical representation may be expressed as a numerical range. The laser output data field preferably is a numerical representation of the output of the laser; alternatively, the numerical representation may be expressed as a numerical range. An alternative embodiment is that each particular laser system will have its own entry if it is involved in a reported incident. A further alternative embodiment is that if a particular laser system is involved in multiple reported incidents that each reported incident will have an entry in the laser systems data table, or the laser systems data table might be split into two separate data tables to reduce redundant data in the database for example, the first five data fields and the next eight data fields with the comments data field being present in both, one or the other, or neither.

The wavelength data table (Wavelength) preferably includes data fields for a unique identification (ID), a laser identification (LaserID), a lambda (Lambda), and a color (Color). The laser identification preferably refers to a particular laser system in the laser systems data table. The lambda data field preferably is a numerical representation of the length of the wavelength, which most preferably is provided in microns using scientific notation. The color data field preferably is a description of the color of the laser light emitted by a laser system identified by the laser identification. An alternative embodiment is to merge the wavelength data table into the laser systems data table. The use of multiple data tables for the laser system allows for efficiencies similar to the bibliographic data table efficiencies, because in part some laser systems are capable of producing lasers of different wavelengths.

The clinical evaluation data table preferably includes data fields for a unique identification (ID), an incident identification (IncidentID), a date (CEDay, CEMonth, CEYear), a facility (Facility), a diagnosis (Diagnosis), a prognosis (Prognosis), a treatment (Treatment), a normal examination indication (Normal), a comment (Comments), and a flag (HasChildren) as illustrated, for example, in FIGS. 3 and 6(e). Preferably, the incident identification relates to an ID in the incident data table. A uniquely assigned identification to each record preferably relates to the clinical evaluation identification in the examination data table. The facility data field preferably provides a description or name of the facility where the particular clinical evaluation was performed and/or occurred. The diagnosis data field preferably is a textual field that allows a description of what the diagnosis was at the conclusion of a particular clinical evaluation. The prognosis data field preferably is a field that allows for a textual description of the prognosis at the conclusion of the particular clinical evaluation. The treatment data field preferably is a field for describing the treatment the subject received and/or was prescribed by the treating medical professional. The normal examination indication data field preferably informs the user whether the results of the clinical evaluation are within normal limits. The comments data field preferably is a textual field for administrative comments about the evaluation. The flag data field preferably indicates whether there were any special examinations performed during or as part of this clinical evaluation preferably to avoid querying the database.

The examination data table preferably includes data fields for a unique identification (ID), a clinical evaluation identification (ClinicalEvalID), an incident identification (IncidentID), an examination type identification (ExamTypeID), a textual examination name (Type), an image flag (HasImages), a date (ExDay, ExMonth, ExYear), an eye field (Eye), an evaluation (Evaluation), examination data (ExamData), and comments (Comments) as illustrated, for example, in FIGS. 3 and 6(f)-(h) (for particular examinations). The unique identifier data field preferably relates to the examination identification in the images data table. The clinical evaluation identification data field preferably relates to the unique identification from the clinical evaluation data table. There may be multiple examinations for a particular clinical evaluation. The examination type identification data field preferably relates to a unique identification in an exam type data table. Alternatively, the data field for the textual examination name may be eliminated, if extra redundancy is less desired. Alternatively, the data field for the incident identification may be eliminated, if extra redundancy is less desired.

The image flag data field preferably provides an indication as to whether there are any associated images connected to a particular examination. The eye data field preferably identifies which eye is examined by a number. The evaluation data field preferably is a written narrative of the results of a particular examination of the subject; more preferably, this data field is an objective evaluation of the exam results. The examination data field preferably includes any data that was gathered during a particular examination.

The images data table (Images) preferably includes data fields for an examination identification (ExamID), an examination type identification (ExamTypeID), an examination type (ExamType), an image format (Format), comments, and image data (ImageData). The examination identification data field preferably relates to a unique identification in the examination data table. The image format data field preferably indicates the form of the image data, for example, JPEG or bitmap. Preferably, the image data is stored in binary form. Alternatively, the image data may be stored outside of the images data table with the image data field preferably including a file location of and/or pointer to where the image data is located.

The examination type data table (ExamType) preferably includes data fields for a unique identification (ID), an examination type (ExamType), and a data format (DataFormat). The unique identification data field preferably relates to an examination type identification (ExamTypeID) in the examination data table. The examination type data field preferably includes a description of the examination type. The data format data field preferably includes an indication as to the format of the data for a particular examination type. An alternative embodiment is that the examination type data table is merged into the examination data table.

Preferably, the types of examination supported include Amsler Grid, contrast sensitivity, Fundus Photo, Hundred Hue, Ishihara, ophthalmic examination, and visual acuity. The Amsler Grid examination tests the visual field for retinal defects such as holes, distortions, etc. The contrast sensitivity examination tests the ability to resolve images with discreet spatial frequencies and contrast. The Fundus Photo examination includes taking images of the retina using various dyes and light sources. The Hundred Hue examination tests color vision using a series of colored “chips” that are organized by the subject according to their color. The Ishihara examination is a color vision test using a series of graphic plates dotted with varying colors to form numbers, letters, and designs. The ophthalmic examination is typically an examination performed by an ophthalmologist. The visual acuity examination tests the ability of the patient to resolve images (usually on an eye chart).

The data format of the examination type data table preferably allows entry of textual data. The Amsler Grid data includes the comments of the subject. The contrast sensitivity data includes measured contrast sensitivity and thresholds. The Fundus photo data includes the dyes used. The Hundred Hue data includes the chip sequence. The Ishihara data includes plate responses. The ophthalmic exam data includes notes and observations of the ophthalmologist. The visual acuity data includes the measured acuity. Preferably, binary image data is stored in an image table. The Ishihara test, the ophthalmic exam, and the visual acuity test preferably do not include images that correspond to the examination.

For the data tables that include a comments data field, the comments data field preferably is for any administrative comments about the entry into the data table that it is associated with. As such, an alternative embodiment is to omit this data field from some or all of the relevant data tables and/or selectively add to other data tables.

### Interface

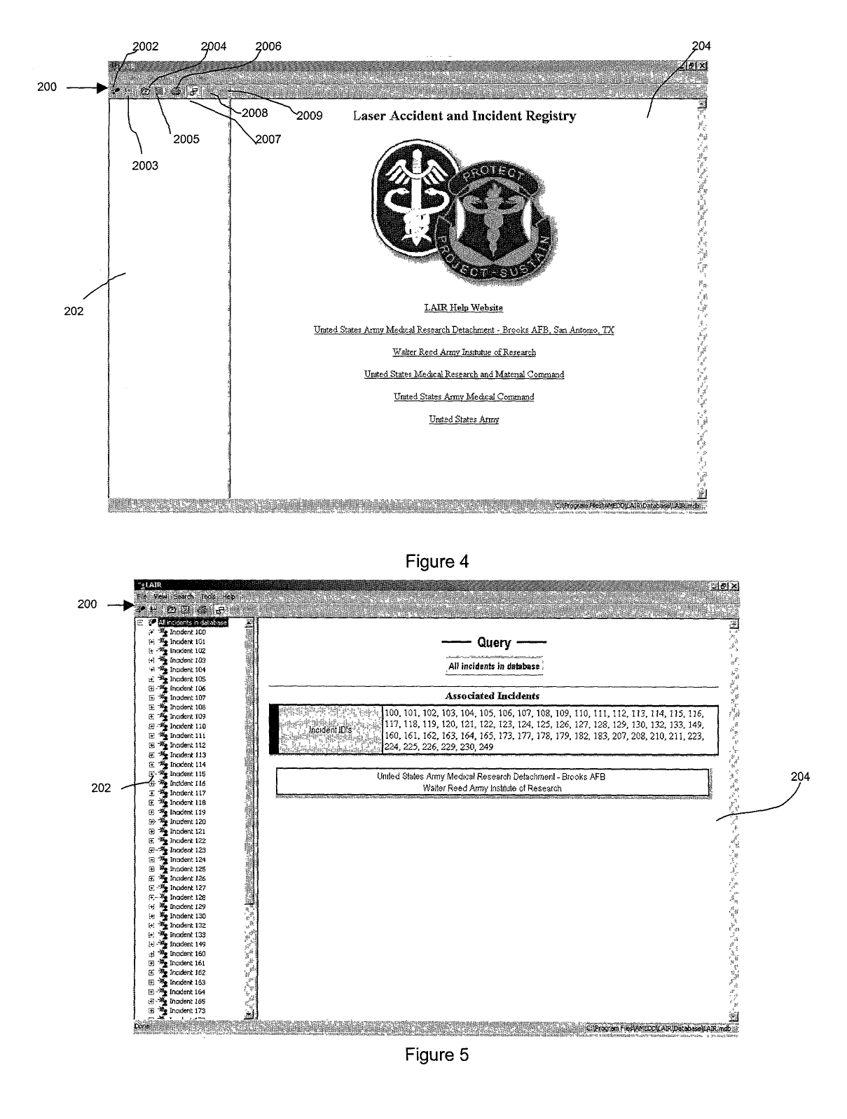

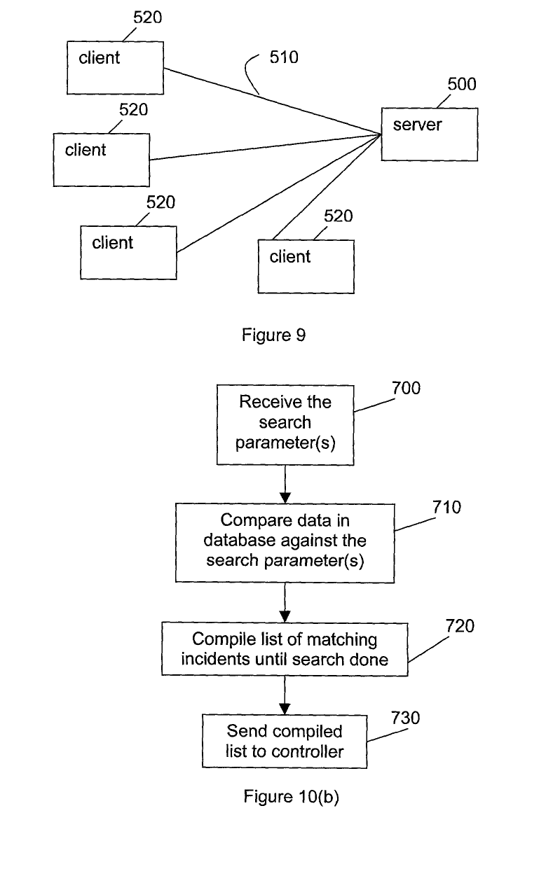

FIGS. 4-9 illustrate a preferred user interface for interacting with the system and the following description will be based on this illustrated interface. The user interface may be resident on the client 520 or a server 500 accessed by the client 520 over a network 510 as illustrated in FIG. 9. One of ordinary skill in the art will realize, based on this description, a variety of interface designs are possible including other visual/graphical user interfaces and/or voice recognition in place of user activated buttons.

The illustrated user interface includes a toolbar 200 with a query button (means for querying information from the database) 2002, a query-refined button 2003, an open query button (means for recalling previous queries) 2004, a query save button 2005, a print button 2006, and a tool tips button 2007. The query save button 2005 preferably is the function that allows the user to save a query to memory, and together the query save button 2005 and memory are a means for storing queries. The illustrated user interface also includes a navigator (or incident navigator) 202 that lists out the located incidents based on an entered search query, which in the illustrated embodiment in FIG. 5 the search query was for all of the incidents. Alternatively, the system may provide a list of all of the incidents present in the database upon entry into the system or some subset such as the last set of search results for that particular client and/or user.

Preferably, the navigator 202 allows for expandable menus for each displayed incident and any sub-subject area below each incident as illustrated, for example, in FIG. 6(a). The navigator 202 in the illustrated example of FIG. 6(a) shows one expanded incident for incident 115, which also is shown in FIG. 6(b). Incident 115 includes a bibliography page (FIG. 6(c)), a laser data page (FIG. 6(d)), and a clinical evaluation page(s) (FIG. 6(e)). The clinical evaluations data pages reference different examinations performed such as an Amsler Grid, a contrast sensitivity test, a Fundus Photo (FIG. 6(f)), a Hundred Hue, an ophthalmic examination (FIG. 6(g)), and a visual acuity examination (FIG. 6(h)). The viewer (or incident viewer) 204 as illustrated in FIG. 5 is displaying the query requested to be search and listing the associated incidents for that particular query. The viewer 204 also is where the data or information selected by the user in the navigator 202 is displayed based on data and information located in the database as illustrated in FIG. 6(a).

Preferably, when the user sees an incident the user wants to view information about, the user will select the item in the navigator 202 to be displayed in the viewer 204 as illustrated in FIG. 6(a) in connection with incident 215. The operation of the user interface is similar to that of Windows Explorer in terms of selecting items and expanding/unexpanding items. Preferably, there is no need to double-click on an item to view it.

The browser tip button 2007 preferably is for obtaining quick information about the data items displayed in the navigator 202. Preferably, to activate this feature, the user clicks on the browser tip button 2007 or select Browser Tips item under the View menu. An example of the information viewable in the popup window is shown in FIG. 7 and resulted from moving the cursor over incident 115.

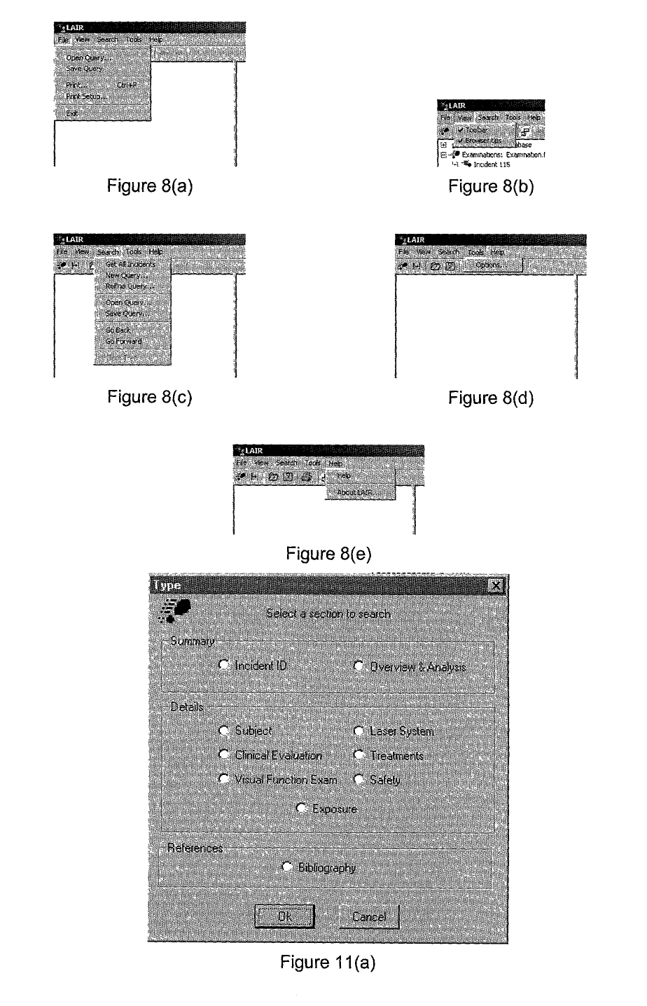

FIGS. 8(a)-(e) illustrate a variety of possible menu items for use as part of the system according to embodiments of the invention.

A user preferably will be able to print results by clicking on the printer button 1006 or selecting Print item under the File menu as illustrated in FIG. 5(a). Examples of printouts are FIGS. 6(a)-(h) for incident 115.

As illustrated in FIGS. 1(b) and 4-7, an aspect of the invention is the creation of displays from templates and the selected data. FIG. 1(b) illustrates the template library 130 being in communication with the interface engine 120, which preferably pulls the respective template from the template library 130 and populates it with data obtained from database 100 based upon a selection received from the controller 140.

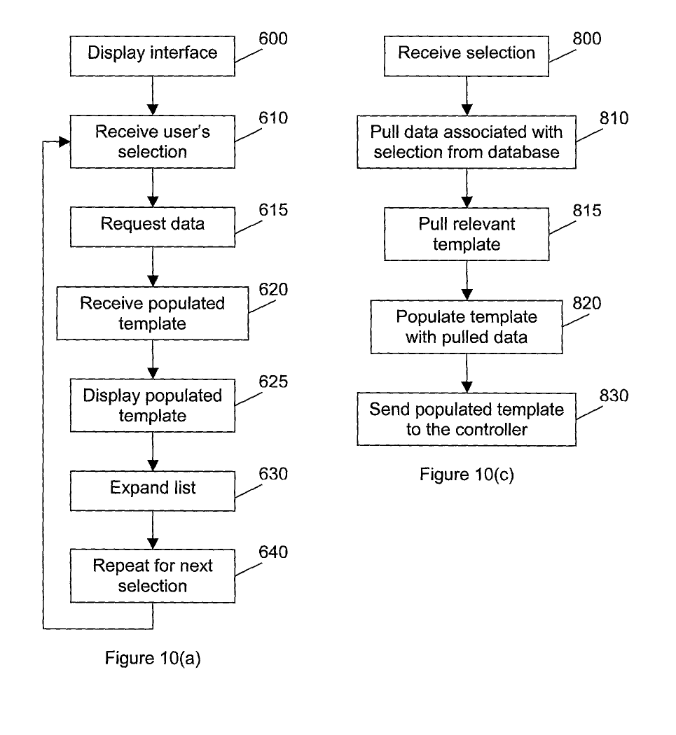

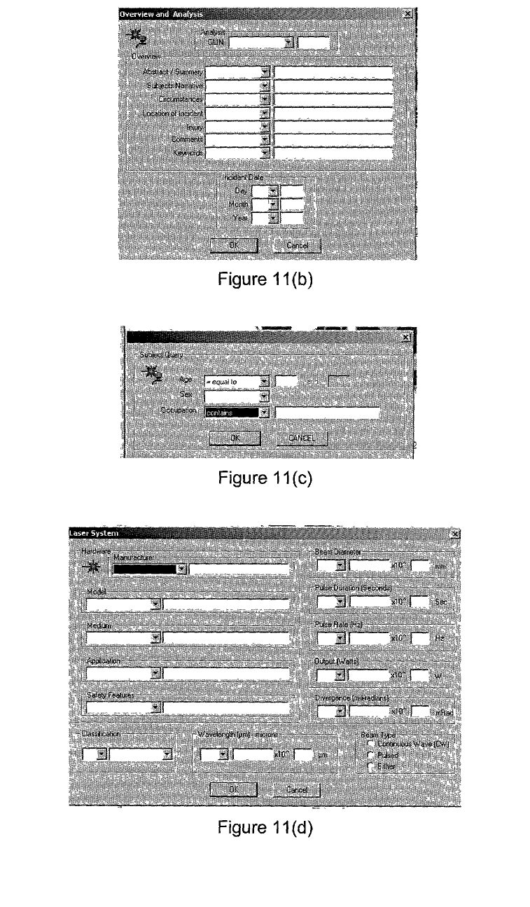

The controller 140 preferably includes the capability to display the interfaces discussed above and illustrated, for example, in FIGS. 4 and 5. The controller 140 directs the interface engine 120 to pull data from the database 100 based upon selections made by the user through the interface. An exemplary method for the operations of the controller 140 is illustrated in FIG. 10(a) and is as follows. Preferably, in step 600 displaying an interface such as discussed in this application or similar interface that includes a list of incidents like that illustrated in FIGS. 5 and 6(a). Preferably, receiving a selection from the user of a particular incident in step 610 and requesting in step 615 the interface engine 120 to pull the data for the selected incident from the database 100 and the incident template from the template library 130. Preferably, in step 620 receiving from the interface engine 120 a populated incident template for display, and then displaying in the viewer 204 the populated template in step 625 as illustrated, for example, in FIG. 6(a). Prior to, while, or after communicating with the interface engine 120 in step 630, expand the first level of entries below the selected incident in the navigator 202 where as a way of example the first level for incident 115 in FIG. 6(a) would be the following: Bibliography, Laser, Clinical Evaluation Apr. 3, 1984, Clinical Evaluation Apr. 5, 1984, Clinical Evaluation Apr. 9, 1984, Clinical Evaluation Apr. 20, 1984, and Clinical Evaluation Apr. 4, 1984. The plus sign in the box preferably indicates that there is another level of information available. Preferably then in step 640, repeat the above steps as long as the user continues to select entries (where reference to incident above can be replaced by any item in the list in the navigator 202) in the list in the navigator 202.

An exemplary method for the operations of the interface engine 120 is illustrated in FIGS. 10(b) and (c) and is as follows. FIG. 10(b) illustrates the method for pulling data from the database upon a search request. Preferably, upon receiving a search parameter(s) from the controller 140 in step 700, the interface engine 120 in step 710 preferably searches (or examines) the data contained within the database 100 for any incidents that satisfy the search parameter(s) sent by the controller 140. Upon finding an incident in the database 100, the interface engine 120 preferably in step 720 compiles a list in memory of the matching incidents. Preferably, upon searching the database 100, the interface 120 sends the controller the compiled list of incidents in step 730, which the controller 140 preferably displays in the navigator 202.

FIG. 10(c) illustrates the method for pulling data from the database 100 and template library 130 based upon a selection by a user. In step 800, preferably the interface engine 120 receives a selection from the controller 140. The interface engine 120, in step 810, pulls the data associated with the selection from database 100 and, in step 815, the relevant template based upon the selection from the template library 130. Preferably, steps 810 and 815 can be done consecutively, in reverse order, or simultaneously; alternatively, there is performance of another step between these two respective steps. In step 820, preferably populating the template with the pulled data. In step 830, preferably sending the populated template to the controller 140 for display.

The communication between the controller 140 and interface engine 120 may occur within the same processing unit and/or across a network or other communication link. In addition, the communication between the interface engine 120 and the database 100 or the template library 130 may occur within the same processing unit and/or across a network or other communication link.

### Query Engine

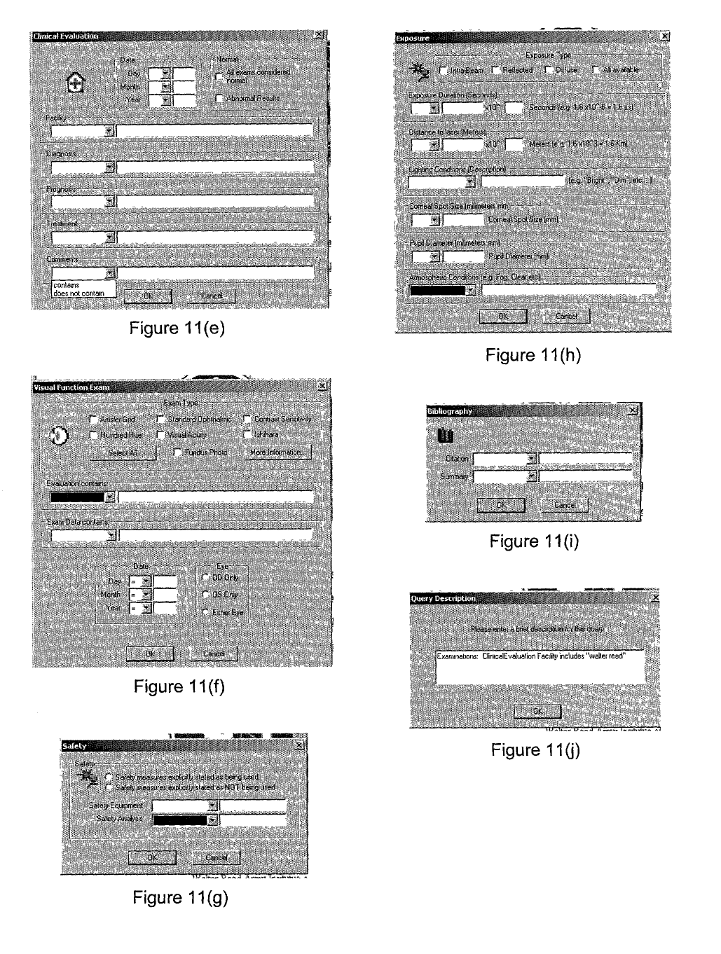

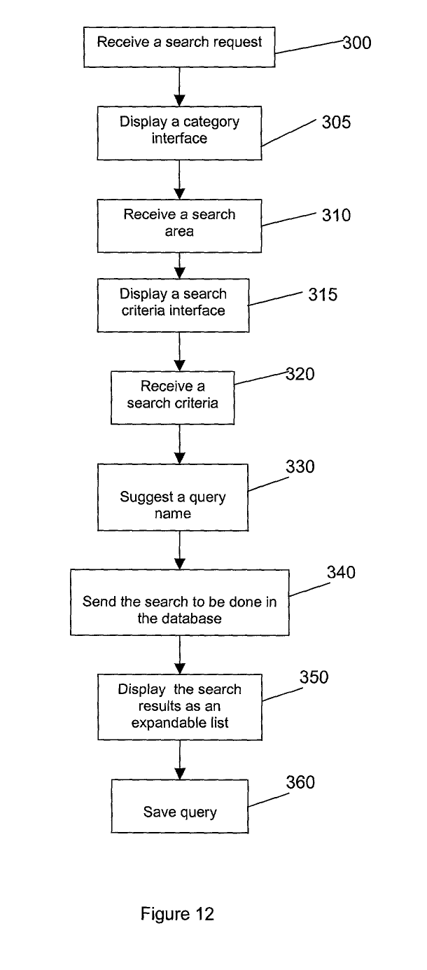

FIGS. 11(a)-12 illustrate, for example, a preferred search method and system as performed by the query engine 160 and/or controller 140. A user may begin a search of the records within the system by either activating the query button 2002 or selecting the query wizard on the Search menu illustrated in FIG. 8(c) in step 300. Either of those ways preferably prompts the appearance of the box illustrated in FIG. 11(a) or a similar request to the user to enter search information, step 305. FIG. 11(a) illustrates that the exemplified embodiment that allows for searches in the functional areas of the incident identification, Overview and Analysis, subject, clinical evaluation, visual function exam, laser system, treatments, safety, exposure, and bibliographic reference. Once a section is selected (step 310), preferably, an appropriate interface will be provided in step 315 for each section that will include lists of data fields for which the user can enter criteria for searching as illustrated, for example, in FIGS. 11(b)-(j).

As the present system is configured, if the user wishes to perform a search in more than one area, then the user will need to run a broad search and then a refined search (either, for example, through the refine search button 2003 in FIG. 4 or the search pulled down menu in FIG. 8(c)). Alternatively, the system can be designed to allow for multiple entries of search parameters to initiate one search in one-step instead of two steps.

The third step of the search (step 320) is to enter the search criteria in the fields available for your search area. FIGS. 11(b)-(j) illustrate exemplary input windows for this step. If a field is left blank, then the field will be excluded from the criteria but the field will not be excluded from the retrieved data. Preferably, the text fields have two options: “contains” and “does not contain.” These two options preferably allow the user to either include or exclude text that is entered. On the other hand, numeric fields preferably offer the options: “less than (<),” “greater than (>),” “equal to (=),” “less than or equal to (≦),” or “greater than or equal to (≧)” as is the case, for example, with wavelength (and other data fields) in the Laser System search criteria shown in FIG. 11(d). Preferably, the system may have the numeric fields allowing entry of numbers using scientific notation. Preferably, after the user has entered as many criteria as the user desires to, the user will press OK or another acknowledgment mechanism. The user preferably then is prompted to enter a name for the query as illustrated in FIG. 11(j). Preferably, if a field that you query against is empty, then the record will not meet your criteria and will not be returned. Alternatively, the search query may be structured using Boolean logic or the user will be given the choice as to search query structure. A further alternative is to provide a natural language search for the textual description fields.

In step 330, if the user does not enter a name for the query, then preferably the system will provide a name for the query based upon the user's selections as illustrated in FIG. 11(j). Preferably, the name is derived from the command sent to the system. Preferably, the user will be given the opportunity to accept the default or enter a name of the user's choice. Next in step 340 and 350, preferably the system executes the query and returns the results to the navigator 202 using the query name as the top level for search results.

Preferably in step 360, if the user wishes to save the query for latter use or review, the user will save the query by clicking on the save button 2005 or use the menu structure to save the query by selecting the Save Query option from the Search menu (FIG. 8(c)). Either of these operations will save the query definition to the default query definition file set in the options menu.

Preferably, when the user wishes to recall a previously saved query, the user will select the Open Query option from the Search menu (see FIG. 8(c)) or the open query button 2004. The user then preferably will be presented a listing of all the saved query definitions in the default query definition file. Preferably, the user may select the query to recall and press OK. The query will be executed and the results loaded into the incident navigator 202.

After a search is performed and the results are returned, the system preferably allows the user to narrow the search by adding additional criteria to the current query. Preferably, the resulting query will be a subset of the previous one. However, if the user wishes to expand the query, rather than narrow it, the user preferably will create a new query.

Preferably, the user will select Refine Query from the Search menu (see FIG. 8(c)) or the refine query button 2003. Either selection mechanism preferably will run the query wizard again. Preferably the system will allow the user the opportunity to name the new query or a default name will be offered by system such as the phrase “(Refinement)” before the default name.

Preferably, queries interpret missing data as a NULL unless the field specifically states that no data was provided. That is, the data does not exist and cannot be queried against. If, for instance, the user queries for all subjects who are less than twenty years old, the system will return only those records that explicitly meet that criterion. If the field is empty (NULL), then the system preferably will determine that the record does not meet the criteria and will not return the record.

The communication that occurs between the controller 140 and the query engine 160 may occur within the same processing unit and/or across a network or other communication link.

### Additional Alternative Embodiments

An alternative embodiment for the system is to provide a help function similar to that present in many different software packages such that a user can perform a search by typing in keywords or browsing through a table of contents. Such a help function might be accessed as illustrated in FIG. 8(e), which also shows an About LAIR option.

A further alternative embodiment is to provide a back button 2008 and a forward button 2009 for moving through the pages that have been displayed in the viewer 204. This movement is without selecting a particular page within the navigator 202. These buttons 2008, 2009 facilitate rapid navigation of the data pages that have been selected for viewing by the user. The user may move forward or backward through the previously displayed data pages. Alternatively, buttons may be provided to move through the pages displayed in the navigator 202.

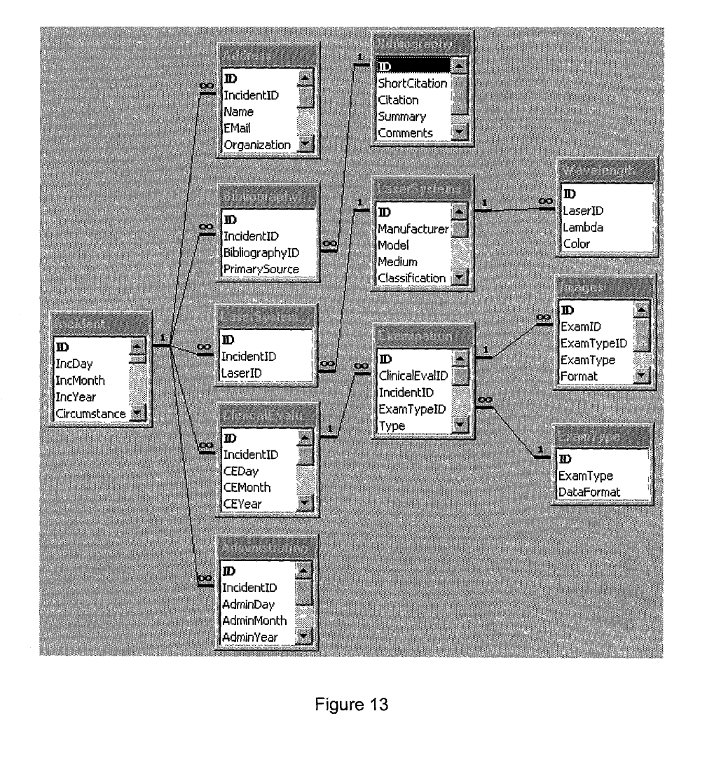

In an alternative embodiment, two additional data tables related to the incident are illustrated in FIG. 13. The data tables are the address and administration data tables. The address table may contain additional information regarding relevant contact information relating to an incident. The administration table provides information relating to entry of a particular incident into the database including, for example, the time, date, and who entered the incident into the system.

Another alternative embodiment, as illustrated in FIG. 13, is to add an administration data table (Administration). This data table preferably includes a unique identification (ID), an incident identification (IncidentID), a date (AdminDay, AdminMonth, AdminYear), a clinic flag (ClinicOnly), a training flag (TrainingData), a data entry (EntryTech), and comments (Comments). The incident identification preferably correlates to the incident ID in the incident data table. The clinic flag data field preferably is a yes/no entry as to whether the information for the incident contains only clinical data. The training flag data field preferably is a yes/no entry as to whether the information for the incident is for training purposes only and not for analysis and/or reference. The data entry data field preferably is a textual entry of the initials of the individual that entered a particular incident into the database; alternatively, the initials may be indexed to a full name and/or may include initials plus a distinguishing difference if more than one individual has the same initials.

In an alternative embodiment, database information (DBInfo) table is used to provide information about the system and the database information. As shown in FIG. 2, possible fields include the release version number, release date, and any additional comments/information. A further alternative embodiment is to provide access to this information in an About box, which may also display the number of incidents contained in the particular database.

The preferred and alternative embodiments described above may be combined in a variety of ways with each other. Furthermore, the data fields discussed above in the preferred and alternative embodiments may be contained and organized in other ways, and, more particularly, an alternative embodiment may be included with some of its particular set of describe data fields but not all of the data fields.

Although the present invention has been described in terms of particular preferred and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. A computer-readable medium containing a data structure for storing laser accident and incident information comprising:
an incident table containing an entry for each of a plurality of incidents, each entry carrying an-identification,
a clinical evaluation table containing at least one entry for each entry in said incident table linked by said identification, said clinical evaluation table containing clinical evaluation information, and
a laser table containing at least one entry for at least one entry in said incident table linked by said identification, said laser table containing a laser identification.

2. The data structure according to claim 1, wherein said clinical evaluation table contains a clinical identification for each entry, said data structure further comprising:
an examination table containing at least one entry that corresponds to at least one entry in said clinical evaluation table linked by the clinical identification, said examination table containing evaluation information and an examination identification.

3. The data structure according to claim 2, further comprising:
an images table containing at least one entry that corresponds to at least one entry in said examination table linked by the examination identification, said images table containing data to form digital representations of the injury occurring from the incident, and
an examination type table containing at least one entry that corresponds to at least one entry in said examination table linked by the examination identification, said examination type table containing an identification of an examination given to an injured subject.

4. The data structure according to claim 1 further comprising a bibliography table containing a corresponding entry for each entry in said incident table linked by said identification, said bibliography table containing bibliographic information for the incident corresponding to said identification.

5. The computer-readable medium according to claim 1, wherein the computer-readable medium is a carrier wave.

6. A system comprising:
means for storing a database of incidents,
means for querying information from said storing means, and
means for displaying information queried from said storing means by said query means.

7. The system according to claim 6, wherein said query means includes:
means for storing query definitions, and
means for recalling previous query definitions from said query storing means.

8. A computer-readable medium containing a data structure for injury information comprising:
an injury table containing an entry for each of a plurality of injuries, each entry having an identification,
a clinical evaluation table containing at least one entry for each entry in said injury table linked by said identification, said clinical evaluation table containing medical information, and
a cause table containing a corresponding entry for each entry in said injury table linked by said identification, said cause table containing a description of how the injury occurred.

9. The data structure according to claim 8, further comprising a source table containing a corresponding entry for each entry in said injury table linked by said identification, said source table containing information relating to the source of the information.

10. A method for performing a search in a database comprising:
receiving a search request,
displaying a radial button interface listing categories,
receiving a selection of a category listed on the radial button interface,
displaying an interface having multiple fields for accepting search criteria,
receiving search criteria,
suggesting a query name,
sending the search criteria to another component,
receiving a list of matches that satisfy the search criteria from the other component, and
displaying the list.

11. The method according to claim 10, further comprising receiving a save instruction and saving the query for later retrieval.

12. The method according to claim 10, further comprising expanding the list to include a additional levels of information when an item is selected.

13. A computer data signal embodied in a carrier wave readable by a computing system and encoding a computer program of instructions for executing a computer process performing the method recited in claim 10.

14. A computer-readable medium having computer-executable instructions for the method recited in claim 10.

15. A method for providing information to a user based upon an input received from the user, said method comprising:
a. displaying a list of incidents,
b. receiving a selection of a particular incident,
c. requesting data related to the selected incident,
d. receiving a populated template including the data related to the selected incident,
e. displaying the populated template, and
f. expanding the list to include related informational categories for the selected incident.

16. The method according to claim 15, further comprising repeating steps b through f for each incident selection by the user.

17. The method according to claim 15, further comprising:
receiving a selection of an informational category,
requesting data related to the selected informational category,
receiving a populated template including the data related to the selected informational category,
displaying the populated template including the data related to the selected informational category, and
when another level of information is available, expanding the list to display the another level of information below the selected informational category.

18. The method according to claim 15, further comprising expanding the list to include a sublevel of information items when an item is selected.

19. A computer data signal embodied in a carrier wave readable by a computing system and encoding a computer program of instructions for executing a computer process performing the method recited in claim 15.

20. A computer-readable medium having computer-executable instructions for the method recited in claim 15.

21. A method for retrieving information from a database and a template, said method comprising:
receiving a selection,
pulling data associated with the selection from a database,
pulling a template associated with the selection from a template library,
populating the template with the pulled data, and
sending the populated template.

22. The method according to claim 21, wherein said populating step includes matching each piece of data with a respective field within the template.

23. A computer-readable medium having computer-executable instructions for the method recited in claim 21.

24. A computer data signal embodied in a carrier wave readable by a computing system and encoding a computer program of instructions for executing a computer process performing the method recited in claim 21.

25. A method for assembling search results of incidents based upon a query, said method comprising:
receiving at least one search parameters from a controller,
comparing the incidents in a database against the at least one search parameter,
compiling a list of matching incidents from the comparing step, and
sending the compiled list of incidents to the controller.

26. A computer-readable medium having computer-executable instructions for the method recited in claim 25.

27. A computer data signal embodied in a carrier wave readable by a computing system and encoding a computer program of instructions for executing a computer process performing the method recited in claim 25.

28. A laser accident and incident registry system comprising:
a controller having a browser,
an interface engine connected to said controller, and
a database storing the laser accident and incident registry, said database connected to said interface engine.

29. The system according to claim 28, further comprising a template library connected to said interface engine.

30. The system according to claim 29, further comprising a client having said controller and a server having said database and said template library, wherein said client is connected to said server through a computer network.

31. The system according to claim 30, wherein said client includes said interface engine.

32. The system according to claim 28, further comprising a query engine connected to said controller.

33. The system according to claim 28, further comprising an icon library connected to said controller.

34. The system according to claim 28, further comprising a client having said controller and a server having said database, wherein said client is connected to said server through a computer network.

35. The system according to claim 34, wherein said client includes said interface engine.
